(19) United States
(12) Patent Application Publication
(10) Pub. No.: US 2024/0372310 A1
(43) Pub. Date: Nov. 7, 2024

(54) OPTICAL ARRANGEMENT HAVING AN AUXILIARY RESONATOR, AND METHOD FOR AMPLIFYING OR FOR CREATING A LASER BEAM

(71) Applicant: TRUMPF Laser GmbH, Schramberg (DE)

(72) Inventors: Dominik Bauer, Rottweil (DE); Thomas Dietz, Koenigsfeld im Schwarzwald (DE); Alexander Killi, Trossingen (DE)

(21) Appl. No.: 18/773,616

(22) Filed: Jul. 16, 2024

Related U.S. Application Data
(63) Continuation of application No. PCT/EP2022/084931, filed on Dec. 8, 2022.

(30) Foreign Application Priority Data
Jan. 18, 2022 (DE) 10 2022 101 088.0

(51) Int. Cl. H01S 3/0941; H01S 3/08; H01S 3/10

(52) U.S. Cl. CPC H01S 3/0941; H01S 3/08; H01S 3/10084

(57) ABSTRACT

An optical arrangement includes a disk-shaped laser-active medium configured to create an optical gain upon being pumped within a pump volume, and a laser beam incoupler for input coupling a laser beam as a seed laser beam into the laser-active medium. The laser beam interacts with the laser-active medium. The optical arrangement further includes an auxiliary resonator for creating an auxiliary resonator radiation field. The auxiliary resonator radiation field interacts with the laser-active medium. The auxiliary resonator is configured to suppress at least one mode of the auxiliary resonator radiation field that overlaps with at least one mode of the laser beam in the pump volume.

### CROSS REFERENCE TO RELATED APPLICATIONS

This application is a continuation of International Application No. PCT/EP2022/084931 (WO 2023/138832 A1), filed on Dec. 8, 2022, and claims benefit to German Patent Application No. DE 10 2022 101 088.0, filed on Jan. 18, 2022. The aforementioned applications are hereby incorporated by reference herein.

### FIELD

Embodiments of the present invention relate to an optical arrangement, in particular as a laser amplifier.

### BACKGROUND

DE 101 47 798 A1 describes a laser amplifier system comprising a laser-active medium in which an inversion density is creatable by pumping within a pump volume. There is an optical gain in at least one mode in the laser-active medium in the laser-active state of a laser amplifier once the inversion density has attained a gain value. An auxiliary oscillator is provided, whose oscillator radiation field at least partially overlaps with a gain volume of the laser amplifier in the laser-active medium. The auxiliary oscillator is designed such that a laser threshold is attained for each mode of the oscillator radiation field at use values of the inversion density within the overlap volume, the laser threshold being greater than the gain value of the inversion density.

In other words, the auxiliary oscillator of DE 101 47 798 A1 is not laser-active whenever the laser amplifier is laser-active. This can avoid an unwanted increase in the inversion density when the laser amplifier is deactivated e.g. due to an unwanted misalignment, and damage to the laser-active medium or adjacent components can be avoided.

U.S. Pat. No. 3,426,286 describes an optical amplifier for amplifying an optical signal which has a plurality of propagating modes. The amplifier comprises a laser which has an active medium arranged in a first resonator, and at least one auxiliary resonator which is optically coupled to the first resonator and comprises means for controlling the gain of each of the modes to be amplified. The means for controlling the modes may comprise means assigned to each of the auxiliary resonators in order to equalize the gain of each of the modes to be amplified.

### SUMMARY

Embodiments of the present invention provide an optical arrangement. The optical arrangement includes a disk-shaped laser-active medium configured to create an optical gain upon being pumped within a pump volume, and a laser beam incoupler for input coupling a laser beam as a seed laser beam into the laser-active medium. The laser beam interacts with the laser-active medium. The optical arrangement further includes an auxiliary resonator for creating an auxiliary resonator radiation field. The auxiliary resonator radiation field interacts with the laser-active medium. The auxiliary resonator is configured to suppress at least one mode of the auxiliary resonator radiation field that overlaps with at least one mode of the laser beam in the pump volume.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of an exemplary embodiment of an optical arrangement in the form of a disk laser amplifier with an auxiliary resonator;

FIG. 2 shows an illustration of a detail of a laser disk of the amplifier from FIG. 1 with a pump volume, according to some embodiments;

FIGS. 3a and 3b show illustrations of a spatial gain distribution in the pump volume of FIG. 2 without an auxiliary resonator and with an auxiliary resonator with a suppressed fundamental mode, according to some embodiments;

FIGS. 4a and 4b show illustrations of a disk laser amplifier analogous to FIG. 1, having a deflection device for creating multiple passages of a seed laser beam through the laser disk, according to some embodiments; and

FIG. 5 shows an illustration of an optical arrangement in the form of a disk laser with an auxiliary resonator according to some embodiments.

### DETAILED DESCRIPTION

Embodiments of the invention provide an optical arrangement, which enable the amplification or the creation of a laser beam with high beam quality. Embodiments of the invention also provide a method for amplifying or for creating a laser beam.

According to some embodiments, an optical arrangement includes a disk-shaped laser-active medium in which an optical gain is creatable by pumping within a pump volume, a laser beam incoupler for input coupling a laser beam into the laser-active medium or a laser beam creation device for creating a laser beam in the laser-active medium, the laser beam interacting with the laser-active material, and an auxiliary resonator for creating an auxiliary resonator radiation field, which interacts with the laser-active material.

The optical arrangement can be a laser amplifier. In this case, the optical arrangement includes a laser beam incoupler for input coupling a seed laser beam, which is intended for amplification and created by a seed laser source, into the optical arrangement. For instance, the laser beam incoupler can be an input coupling mirror, a collimation lens for collimating the seed laser beam divergently emerging from an optical fiber, etc. Alternatively, the optical arrangement can be a laser, for instance a disk laser, wherein the laser beam is created in the laser-active medium without a seed laser beam being required to this end.

According to embodiments of the invention, the auxiliary resonator is designed to suppress at least one mode of the auxiliary resonator radiation field which overlaps with at least one mode of the laser beam—in part or in full—in the pump volume. The auxiliary resonator typically is a multimode resonator, i.e., a resonator designed to create at least two modes, of which at least one mode is not suppressed. Within the pump volume, the non-suppressed mode(s) of the auxiliary resonator radiation field ideally have as little overlap as possible with the laser beam.

The pump volume (pump spot) forms a typically circular region in the laser-active medium, in which an optical gain is created in the laser-active medium. In the case where a laser beam with a Gaussian intensity distribution is amplified, the laser beam is unable to interact sufficiently with the laser-active medium at the edges of the pump volume on account of the decrease in the intensity, and so the energy stored there cannot be extracted unless the pump profile likewise has a Gaussian intensity distribution, and this is generally not the case. The upshot is a spatially dependent, non-constant gain distribution in the pump volume, which has non-constant heating of the laser-active medium in the pump volume as a consequence. This may result in refractive index changes and an expansion of the laser-active medium, resulting in a non-constant phase distribution over the beam cross section of the laser beam amplified in the optical arrangement or of the laser beam created in the optical arrangement. The spatially dependently inhomogencous phase distribution leads to diffraction effects and to a deterioration in the beam quality, especially if use is made of a linear multipass amplifier, in which stops are generally not used for the purpose of compensating for the diffraction effects. To avoid or at least reduce this, the unused energy stored in the edge regions of the pump volume is extracted with the aid of the auxiliary resonator radiation field, whereby, in the ideal case, a constant gain is created in the pump volume or at least in a laser field volume within the pump volume, from which a constant phase of the laser beam may result. At least one mode of the auxiliary resonator radiation field which overlaps in full or at least in part with a mode of the laser beam is suppressed in order to prevent the auxiliary resonator radiation field from reducing the gain of the laser beam or in order to obtain a gain distribution in the pump volume that is as homogeneous as possible.

In an embodiment, the auxiliary resonator is designed to suppress at least one fundamental mode of the auxiliary resonator radiation field. The fundamental mode typically has a Gaussian intensity distribution which, proceeding from the beam axis of the auxiliary resonator radiation field, has the smallest radial extent of all modes of the auxiliary resonator. The dimension of the lateral extent of the fundamental mode in the radial direction depends on the design of the auxiliary resonator. As a rule, the auxiliary resonator is a highly multimode oscillator, wherein one or more higher modes are also suppressed in addition to the fundamental mode in order to create a radiation field in the pump volume as adapted as finely as possible. The problem described further above relating to a poor beam quality is particularly pronounced in the case of a laser beam which propagates only in the fundamental mode. As a result of suppressing the fundamental mode and, as a rule, a plurality of higher modes (see above), the auxiliary resonator radiation field has a substantially ring-shaped beam profile with one or more modes to extract the energy stored in the edge region of the pump volume and obtain a gain distribution and hence phase distribution of the amplified or the created laser beam that is as homogeneous as possible.

In a further embodiment, the auxiliary resonator has at least one mode suppression element for suppression of the at least one mode of the auxiliary resonator radiation field. As a rule, it is not possible to construct an (auxiliary) resonator which creates only desired, generally higher modes without mode suppression elements being provided, which for instance suppress the fundamental mode and optionally specific higher modes in targeted fashion.

In a development, the mode suppression element for suppressing the at least one mode comprises a radiation-suppressing, in particular radiation-absorbing or scattering region which is preferably arranged centrally in relation to a beam axis of the auxiliary resonator radiation field.

The radiation-suppressing region is typically formed on a reflective or transmissive optical element of the auxiliary resonator. For instance, the radiation-suppressing region can be formed as an (e.g., central) opening in a reflective optical element of the auxiliary resonator, which may be in the form of a perforated mirror, for example. The radiation-suppressing region can also be created by virtue of a reflective optical element, for example an end mirror of the auxiliary resonator, being structured, for instance by virtue of having a lower reflectivity in the radiation-suppressing region than outside the radiation-suppressing region. The simplest case may see no reflective coating applied in the radiation-suppressing region; however, it is also possible to provide there a reflective coating whose reflectivity is lower than that outside the radiation-suppressing region, i.e., the reflective coating may have a lateral gradient of the reflectivity, wherein the reflectivity may also decrease incrementally. However, the radiation-suppressing region can also be created differently, for example by virtue of the radiation-suppressing region being designed as a scattering region or as a scattering surface or the like.

If the mode suppression element is applied at a transmissive optical element, then the radiation-suppressing region generally is a radiation-absorbing region. In this case, the mode suppression element can for instance be what is known as an “inverse” stop, i.e., a transmissive optical element, e.g., in the form of a plane plate, which for example is provided with an absorbing or scattering coating in the center in order to suppress the fundamental mode.

In a further embodiment, the auxiliary resonator comprises a setting device for setting a power loss of the auxiliary resonator. Being able to set the power of the non-suppressed mode(s) of the auxiliary resonator radiation field in the pump volume is expedient with regards to the homogenization of the gain distribution in the laser-active medium.

In a development, the setting device forms an output coupling device of the auxiliary resonator which is designed to set a power component of the auxiliary resonator radiation field output coupled from the auxiliary resonator. In this case, use is made of a variable, adjustable output coupling device in order to set the output coupled power component and hence the remaining power of the auxiliary resonator radiation field within the auxiliary resonator. There are a number of options for realizing such an output coupling device.

In one development, the output coupling device comprises a polarization-influencing element and a partially transmissive polarization-dependent reflector. For instance, the partially transmissive polarization-dependent reflector can be a thin-film polarizer which reflects a first polarization component of the auxiliary resonator radiation field and transmits a second polarization component of the auxiliary resonator radiation field perpendicular to the first. The polarization-influencing optical element can be a phase-shifting optical element, for instance a quarter wave plate. The quarter wave plate can be rotated about the beam axis of the auxiliary resonator radiation field in order to set the power loss or the radiation component transmitted, e.g., to a beam trap at the reflector. In the simplest case, the quarter wave plate can in this case be rotated manually about the beam axis by an operator.

In an advantageous development, the optical arrangement comprises a control device for controlling the setting device for setting the power loss of the auxiliary resonator, in particular in continuous fashion. In this case, the power loss can be set automatically with the aid of the control device, for instance by virtue of the latter acting on an actuator or the like in order to (continuously) rotate or align the phase-shifting optical element at a desired angle to the beam axis of the auxiliary resonator.

In a further development, the control device is designed or programmed to set the power loss of the auxiliary resonator such that a substantially spatially constant optical gain is created in at least a ring-shaped portion of the pump volume, in particular in the entire pump volume of the laser-active medium.

A substantially spatially constant gain is understood to mean a gain that deviates by no more than +/−30%, preferably by no more than +/−20%, from a mean value of the gain g. When determining the value for the gain, it is possible to give no consideration to a narrow, ring-shaped edge region of the pump volume which directly adjoins the outer edge of the laser-active medium and whose (double) width in the radial direction is typically no more than 5% of the entire diameter of the pump volume. The gain in the pump volume reduces in this edge region for geometric reasons since the gain is at (virtually) zero outside of the pump volume. As an alternative to creating a constant gain in the entire pump volume, it is optionally possible to form one or more ring-shaped portions in the pump volume, each of which has a substantially constant gain. The same applies to a central, generally ring-shaped portion of the pump volume. To this end, the auxiliary resonator may optionally be designed to set the power loss of the auxiliary resonator in mode-dependent fashion. In this case, a stepwise constant gain in the radial direction is typically created in the pump volume. A high beam quality can also be achieved in this case should the diameter of the central portion of constant gain be greater than the diameter of the laser beam to be amplified.

In a further embodiment, the laser beam creation device forms a resonator in which the laser-active medium is arranged, with the resonator preferably comprising two reflectors, for example two mirrors, for delimiting a resonator path at the ends. In this case, the optical arrangement is a (disk) laser, i.e., the laser beam is created in the laser-active medium of the resonator. The laser-active medium may be applied to one of the two reflectors which delimit the resonator path at the ends; however, it is also possible for the laser-active medium to be arranged at a distance from the two reflectors.

In a further, alternative embodiment, the laser beam incoupler is designed to input couple a seed laser beam into the laser-active medium. In this case, the optical arrangement forms a (disk laser) amplifier, i.e., the seed laser beam is amplified in the laser-active medium. As has been described further above, the input coupling device can be a lens, a mirror, . . . , serving to adapt the seed laser beam created in a seed laser source and/or to align said seed laser beam in the direction of the laser-active medium. On account of the comparatively low thickness of the laser-active medium, it is advantageous in this case for the seed laser beam to pass through the laser-active medium multiple times in order to create the greatest possible gain.

In a further embodiment, a reflector is arranged on one side of the disk-shaped laser-active medium. For instance, the reflector can be a reflective coating applied to the back side of the disk-shaped laser-active medium. The laser beam passes through the laser-active medium twice on account of the reflector. In this case, the laser-active medium can be fastened, especially on its back side, to a heat sink, for example be adhesively bonded, soldered or bonded to the latter.

In one development, the optical arrangement comprises a deflection device for deflecting the laser beam, which was reflected at the reflector, back to the laser-active medium. The number of passages through the disk-shaped laser-active medium for the purpose of amplifying the (seed) laser beam can be further increased with the aid of a deflection device designed in particular for multiple deflection of the laser beam back to the laser-active medium. It is self evident that a deflection device for multiple deflection of the laser beam back to the laser-active medium can also be used in the case where no reflector is formed on the laser-active medium.

In a further development, the deflection device comprises a plurality of reflective elements on which mirror surfaces for deflecting the laser beam are formed, the mirror surfaces of the reflective elements each being aligned such that the laser beam is deflected from a respective mirror surface to another mirror surface via the laser-active medium. A multiple passage of the laser beam through the laser-active medium can be realized particularly casily with the aid of such an arrangement of (typically plane) mirror surfaces. It was found to be advantageous if the reflective optical elements of the deflection device are permanently secured to a common base plate in order to ensure that the mirror surfaces maintain a desired alignment relative to one another.

In a further embodiment, the optical arrangement comprises a pump radiation incoupler for input coupling pump radiation into the laser-active medium for the purpose of creating the optical gain within the pump volume. For instance, the pump radiation incoupler may comprise a collimation lens or the like, in order to collimate the pump radiation divergently emerging from a transport fiber or from a pump radiation source before it is incident on a reflection surface. The reflection surface can for instance be a parabolic mirror or the like, which focuses the pump radiation on the laser-active medium, wherein the pump radiation may be caused to pass through the laser-active medium multiple times with the aid of the reflection surface and with the aid of deflection device(s).

A further aspect of the invention relates to a method for amplifying or for creating a laser beam. The method includes pumping a disk-shaped laser-active medium within a pump volume for the purpose of creating an optical gain, and input coupling the laser beam into the laser-active medium or creating the laser beam in the laser-active medium. The laser beam interacts with the laser-active medium. The method further includes creating an auxiliary resonator radiation field by means of an auxiliary resonator, the auxiliary resonator radiation field interacting with the laser-active medium, and at least one mode of the auxiliary resonator radiation field which overlaps with at least one mode of the laser beam in the pump volume being suppressed. As has been described further above, the auxiliary resonator for suppressing the at least one mode may comprise at least one mode suppression element.

In a variant of the method, a power loss of the auxiliary resonator for creating the auxiliary resonator radiation field is set such that a substantially spatially constant optical gain is created in at least an in particular ring-shaped portion of the pump volume, in particular in the entire pump volume of the laser-active medium. As has been described further above, the pump volume is a typically circular or cylindrical volume within the disk-shaped laser-active medium, the stored energy from the edge region of which being extracted with the aid of the auxiliary resonator. A desired spatially dependent gain distribution and hence phase distribution can be set in the pump volume by way of suitably setting the power loss of the auxiliary resonator. To create a high beam quality, the gain distribution should be ideally constant in the entire pump volume (with the exception of the above-described edge region) during stationary operation.

In one variant, the laser beam is created in a resonator containing the laser-active medium, i.e., the laser beam is created in the laser-active medium or in the resonator containing the latter.

In a further variant, the laser beam is input coupled into the laser-active medium as a seed laser beam. As has been described further above, the seed laser beam created by a seed laser source can be input coupled into the laser-active medium with the aid of a laser beam incoupler or with the aid of an input coupling optical unit.

Even though the optical arrangement and the method have been described in the context of a disk-shaped laser-active medium, the principles described further above can also be applied to other laser-active (solid-state) media.

Further advantages of the invention are evident from the description and the drawing. Likewise, the features mentioned above and those that are yet to be presented may be used in each case by themselves or as a plurality in any desired combinations. The embodiments shown and described should not be understood as an exhaustive list, but rather are of exemplary character for describing embodiments the invention.

In the following description of the drawings, identical reference numerals are used for identical or functionally identical components.

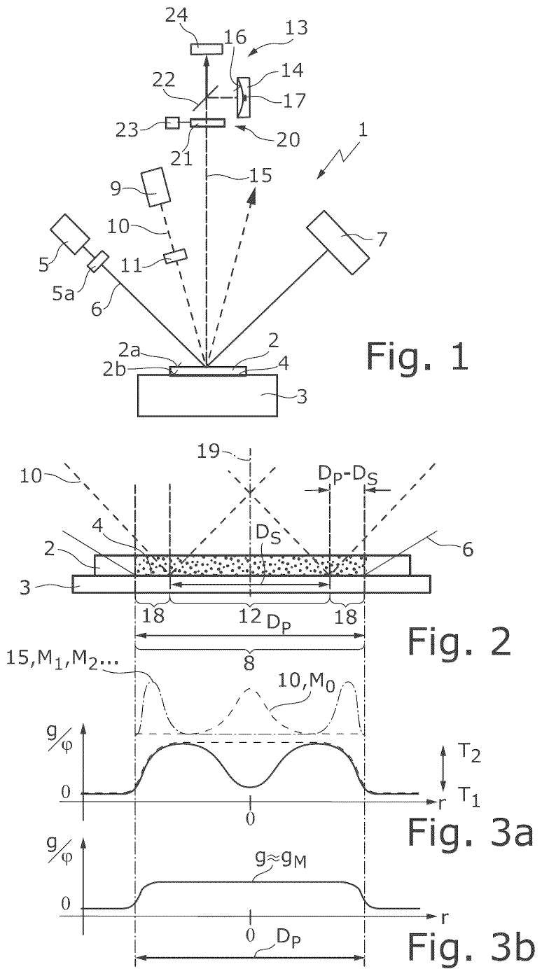

FIG. 1 shows an exemplary structure of an optical arrangement in the form of a disk laser amplifier 1 having a disk-shaped laser-active medium referred to below as a laser disk 2. The laser disk 2 is fastened to a heat sink 3 and comprises a reflector in the form of a reflective coating 4 on its side (back side 2b) facing the heat sink 3. The disk laser amplifier 1 also comprises a pump radiation source 5, which serves to create pump radiation 6 for pumping the laser disk 2. The pump radiation 6 is input coupled into the laser disk 2 via a pump radiation incoupler 5a, which may be in the form of a collimation lens, for example. In this case, the pump radiation 6 enters the laser disk 2 on a side (front side 2a) distant from the heat sink 3, is reflected at the reflective coating 4, and is incident on an end mirror 7 which reflects the pump radiation 6 back to the laser disk 2. It is understood that the laser disk 2 need not necessarily be operated in reflection; instead, it can also be operated in transmission. Rather than a laser disk 2, the laser-active medium can also be a laser rod or the like.

The beam path of the pump radiation 6 depicted in FIG. 1 is depicted in simplified fashion; as a rule, the pump radiation 6 is focused on the laser disk 2 by means of a focusing device, for instance by means of a concave mirror, and is reflected back to the focusing device and, from the latter, to the laser disk 2 multiple times with the aid of a deflection device for the purpose of creating a multiplicity of passages through the laser disk 2, for instance as described in WO 2012/110389 A1, the entirety of which is incorporated in the content of this application by reference. A pump volume 8 (pump spot) with a (pump) diameter DP is created in the laser disk 2 as a result of the pump radiation 6 and is depicted in FIG. 2 using dotted lines. In the example shown, the beam profile of the pump radiation 6 is a flat top profile. It is self evident that, as a rule, the pump volume 8 need not have such a steeply dropping-off edge as depicted in FIG. 2. The (pump) diameter of the pump volume 8 is defined as the region in which the pump power in the laser disk 2 drops to half its maximum value (full width at half maximum (FWHM) value).

The disk laser amplifier 1 also comprises a seed laser 9 which radiates a laser beam 10 to be amplified on the laser disk 2 or which input couples the laser beam 10 into the laser disk 2 via a laser beam incoupler 11. For instance, the laser beam incoupler 11 may comprise a collimation lens serving to collimate the laser beam 10 before the latter enters the laser disk 2. It is understood that the laser beam incoupler may also comprise other reflective or transmissive optical elements. The laser beam incoupler 11 may also serve to adapt the beam parameters of the laser beam 10 before the latter enters the laser disk 2. The laser beam 10 is reflected at the back side 2b of the laser disk 2 and leaves the disk laser amplifier 1 with amplified power. In the example shown, the seed laser beam 10 created by the seed laser 9 has a Gaussian beam profile, i.e., the seed laser beam 10 propagates in a fundamental mode M0, as depicted in FIG. 3a. It is understood that a seed laser beam 10 with a beam profile that deviates from a Gaussian beam profile can also be amplified, i.e., a seed laser beam 10 having a beam quality factor M2 for which M2=1 does not apply, for instance a seed laser beam 10 with M2=2. In the laser disk 2, the seed laser beam 10 passes through a laser field volume 12 which has a smaller diameter DS than the diameter DP of the pump volume 8 (cf. FIG. 2). In the case of a good adjustment, the diameter DS of the laser field volume 12 is approx. 80% of the diameter DP of the pump volume 8. The diameter DS of the laser field volume 12 is understood to mean the FWHM value.

The pump radiation 6 creates a spatially dependent gain g in the laser disk 2; it is depicted in FIG. 3a as a function of the distance r from the center of the laser disk 2 by way of a dashed curve. The size of the pump volume 8 or the diameter DP of the pump volume 8 determines the region in which the gain g is created in the laser disk 2. If the extent of the pump volume 8 or its diameter DP is (significantly) larger than the lateral extent of the laser beam 10 or the diameter DS of the laser field volume 12 in the laser disk 2, as depicted in FIG. 3a, then the energy deposited in the laser disk 2 is not extracted from the lateral edges of the pump volume 8, while the gain g at the center of the laser disk 2 or at the center of the pump volume is extracted by the seed laser beam 10. This creates a local, spatially dependent distribution of the gain g in the pump volume 8 which has a minimum (minimal temperature T1) at the center of the laser disk 2 and a maximum (maximal temperature T2) in a ring-shaped region around the center in the example shown; this can be identified in FIG. 3a on the basis of the solid curve of the optical gain g. It is self evident that the temperature distribution need not necessarily have a profile as depicted in FIG. 3a; however, the temperature distribution is typically not constant over the pump volume 8, but varies in spatially dependent fashion.

As has been presented further above, a non-constant temperature distribution, i.e., a temperature gradient, arises from the non-uniformly distributed gain g over the pump volume 8 in the lateral direction, and hence there is a non-constant phase distribution o in the beam profile of the (amplified) seed laser beam 10, adversely affecting the beam quality of the amplified seed laser beam 10. This effect is particularly pronounced for a seed laser beam 10 propagating in the Gaussian fundamental mode M0 since the intensity of the beam profile of the seed laser beam 10 drops significantly in this case in the edge region 18, while the pump radiation 6 having a flat top profile is approximately constant at the edge of the pump volume 8.

The disk laser amplifier 1 comprises an auxiliary resonator 13 for the purpose of extracting the gain g from the laser disk 2 in the edge region 18, in which the laser field volume 12 of the seed laser beam 10 has a different intensity to that in the center, and for the purpose of thus creating an ideally (substantially) locally constant optical gain g and hence a constant phase angle φ in the lateral direction within the pump volume 8, as depicted in FIG. 3b. The auxiliary resonator 13 forms a resonator path, along which an auxiliary resonator radiation field 15 is created, between the reflector 4 on the back side 2b of the laser disk 2 and a resonator end mirror 14 of the auxiliary resonator 13.

In order to extract the unused energy from a radially outer edge region of the pump volume 8, a multi-mode resonator, in which not only the fundamental mode M0 but also (at least one) higher mode(s) M1, M2, . . . are excited, is used as auxiliary resonator 13. While, when suitably adapted, the energy of the fundamental mode M0 is restricted tightly around the center of the laser disk 2 or the beam axis of the auxiliary resonator 13 in the lateral direction, higher modes M1, M2, . . . of the optimally adjusted auxiliary resonator 13 have lower proportions of the power distribution in the vicinity of the beam axis or in the vicinity of the center of the laser disk 2. For this reason, a (highly) multi-mode auxiliary resonator 13 is able to extract the unused stored energy in the lateral edge regions of the pump volume 8 which are not sufficiently extracted by the seed laser beam 10.

In order to create the gain g described further above that is as constant as possible and the constant phase angle φ in the lateral direction over the pump volume 8 of the laser disk 2, it is advantageous if the auxiliary resonator 13 extracts as little energy as possible from the vicinity of the center of the laser disk 2 as this additionally amplifies the effect described further above, and as much energy as possible is intended to be input coupled into the amplified laser beam 10. To achieve this, the auxiliary resonator 13 is designed to suppress the fundamental mode M0 of the auxiliary resonator radiation field 15 such that only the higher modes M1, M2, . . . are present in the auxiliary resonator radiation field 15, and so it has a substantially ring-shaped power distribution as depicted in FIG. 3a. Since, depending on the design of the auxiliary resonator 13, it is possibly insufficient to suppress only the fundamental mode M0, the auxiliary resonator 13 can also be designed to suppress higher modes M1, M2, . . . of the auxiliary resonator radiation field 15, unlike what is depicted in FIG. 3a.

To suppress the fundamental mode M0, the auxiliary resonator 13 has a mode suppression element 17. In the example shown, the mode suppression element is a portion 17, provided without a reflective coating, of a reflective surface 16 formed on the auxiliary resonator end mirror 14. The portion 17 where no reflective coating has been applied to the surface 16 is arranged centrally in relation to a beam axis 19 (cf. FIG. 2) of the auxiliary resonator radiation field 15. In the ideal case, i.e., in the case of a perfect adjustment, the beam axis 19 of the auxiliary resonator radiation field 15 corresponds to the center axis of the laser disk 2 and runs through the center of the pump volume 8. As an alternative to the non-reflective portion 17, the mode suppression element 17 can for instance be embodied in the form of a central drilled hole in the auxiliary resonator end mirror 14, or the radiation-suppressing region 17 can be designed differently.

For instance, the radiation-suppressing region 17 can form a gradient coating, i.e., the reflective coating has a lateral gradient of the reflectivity, which reduces toward the beam axis 19 of the auxiliary resonator radiation field 15. The radiation-suppressing region 17 may also have a plurality of portions with different levels of reflectivity, arranged for example in ring-shaped fashion about the beam axis 19 of the auxiliary resonator radiation field 15, with the reflectivity reducing incrementally toward the beam axis 19. It is understood that there is a multitude of further options for configuring the radiation-suppressing region 17, a comprehensive description of which cannot be provided here. It may also be advantageous to image the laser disk 2 on the auxiliary resonator end mirror 14.

The mode suppression element 17 is used in the example shown only to suppress the fundamental mode M0 of the auxiliary resonator radiation field 15, the energy of which is concentrated around the beam axis 19 of the auxiliary resonator laser beam 15. In this way, the pump volume 8 of the laser disk 2 is pervaded by the auxiliary resonator radiation field 15 substantially only in an auxiliary resonator laser field volume 18, which corresponds to the radially outer edge region of the pump volume 8 with a lateral extent DP-DS depicted in FIG. 2. Since the fundamental mode M0 of the auxiliary resonator radiation field 15 overlaps virtually completely with the fundamental mode M0 of the seed laser beam 10, the auxiliary resonator laser beam 15 would extract additional energy from the laser disk 2 within the laser field volume 12 without such suppression. The non-suppressed higher modes M1, M2, . . . of the auxiliary resonator radiation field 15 by contrast extract energy as desired from the laterally outer edge of the pump volume 8 where the latter does not overlap with the laser field volume 12 of the seed laser beam 10. As has been described further above, it may be advantageous for higher modes M1, M2, . . . of the auxiliary resonator radiation field 15 to additionally also be suppressed, depending on the design of the auxiliary resonator 13.

The auxiliary resonator 13 is designed such that bending of the laser disk 2 on account of the heating when pumping with the pump radiation 6 is pre-compensated. The reflective surface 16 of the auxiliary resonator end mirror 14 is curved in the example shown, with the curvature of the disk varying with the pump power. Criteria for setting the curvature of the auxiliary resonator end mirror 14 (in the non-radiated state) are the mode quantities on the optical components and the stability of the auxiliary resonator 13. The curvature of the laser disk 2 can be kept constant with the aid of an adjustable output coupling mechanism.

In order to achieve that the profile of the phase angle φ or of the optical gain g in the pump volume 8 is as constant as possible, the use of a mode suppression element 17 generally additionally needs to be supplemented by suitable influencing of the losses of the auxiliary resonator 13 in order thus, ideally, to saturate the gain g in the lateral edge region of the pump volume 8 to a value which approximately corresponds to the gain g in the center of the laser disk 2. For this purpose, the auxiliary resonator 13 comprises a setting device 20 for setting the losses of the auxiliary resonator 13, embodied as a settable output coupling device (variable outcoupler) in the example shown.

The settable output coupling device 20 allows output coupling of a settable component of the power of the auxiliary resonator radiation field 15 from the auxiliary resonator 13. To this end, the settable output coupling device 20 comprises a polarization-influencing element 21, for instance in the form of a quarter wave plate, and a partially transmissive polarization-dependent reflector 22 in the form of a thin-film polarizer. The disk laser amplifier 1 also comprises a control device 23 which acts on an actuator, not depicted here, which rotates the quarter wave plate about the beam axis 19 of the auxiliary resonator radiation field 15 in order to modify the polarization of the auxiliary resonator radiation field 15, whereby the power component of the auxiliary resonator radiation field 15 transmitted by the thin-film polarizer 22 and output coupled from the auxiliary resonator 13 changes. The disk laser amplifier 1 comprises a beam trap 24 for absorbing the power output coupled from the auxiliary resonator 13.

The control device 23 or the actuator acting on the quarter wave plate 21 enables a continuous rotation and hence a continuous adjustment of the losses or the power loss of the auxiliary resonator 13. The more power present in the auxiliary resonator 13, the more energy is extracted from the lateral edge region of the pump volume 8. To create a spatially dependent gain g that is as homogeneous as possible in the pump volume 8, it is necessary for the auxiliary resonator 13 to extract power from the lateral edge region 18 of the pump volume 8 that is comparable to the power extracted by the laser beam 10 in the central laser field volume 12. In particular, the control device 23 allows the losses or the power loss of the auxiliary resonator 13 to be set in such a way that a substantially constant gain g or phase angle φ sets in in the pump volume 8. A substantially constant gain g is understood to mean a gain which, with the exception of a narrow edge region of the pump volume 8 immediately adjoining the outer edge of the laser disk 2 and making up no more than approx. 5% of the diameter DP of the pump volume 8, indicated in FIG. 3b, deviates by no more than +/−30%, preferably by no more than +/−20%, from a mean value gM of the gain g (without giving consideration to the narrow edge region), i.e., g gM applies. This can ensure that the amplified seed laser beam 10 has an approximately constant phase angle q and hence a high beam quality upon exit from the disk laser amplifier 1.

Optionally, it may be sufficient for the gain g to not be substantially constant over the entire pump volume 8, but only be constant in a central, circular portion and in one or more ring-shaped portions, i.e., the gain g has a stepwise constant gain g as a function of the radius r. A high beam quality of the amplified laser beam 10 can also be achieved in this case if the diameter of the central, circular portion is greater than the diameter of the laser beam 10.

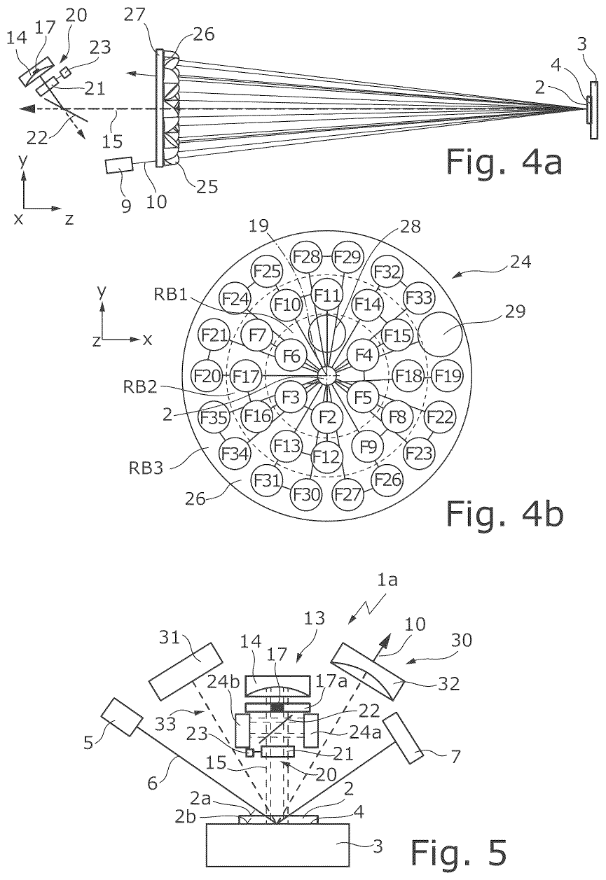

FIG. 4a and FIG. 4b show a disk laser amplifier 1 constructed analogously to the disk laser amplifier 1 shown in FIG. 1, with the illustration making do without the pump radiation source 5 and the pump radiation 6 for reasons of clarity. To enable a multiple pass of the seed laser beam 10 through the laser disk 2, the seed laser beam 10 is deflected multiple times with the aid of a deflection device 25 in the case of the disk laser amplifier 1 shown in FIGS. 4a,b. To this end, the deflection device 25 comprises a plurality of reflective optical elements 26 in the form of deflection mirrors, the seed laser beam 10 being deflected at their mirror surfaces F2 to F35 (cf. FIG. 4b). The reflective optical elements 26 are fastened to a planar main body 27 of the deflection device 25, which is not described in detail here. The planar main body 27 is aligned parallel to the XY-plane of an XYZ-coordinate system and parallel to the laser disk 2 in the example shown, although this is not mandatory. For instance, the planar main body 27 can be tilted with respect to the laser disk 2, and the reflective optical elements 26 can compensate for the global tilt of the main body 27.

As evident from FIG. 4b, the seed laser beam 10 initially passes via a first through opening 28 through the planar main body 27 and, in the process, is aligned such that it is incident centrally on the laser disk 2 and reflected at the latter, more precisely at the reflective back side 2b of the latter, to a second mirror surface F2. At the second mirror surface F2, the seed laser beam 10 emanating from the laser disk 2 is deflected or reflected directly to a third, adjacent mirror surface F3. The third mirror surface F3 is aligned in relation to the laser disk 2 such that the seed laser beam 10 is deflected or reflected back to the laser disk 2 from the third mirror surface F3. At the laser disk 2, the seed laser beam 10 is deflected to a fourth mirror surface F4, and said seed laser beam is reflected from the latter directly to a fifth mirror surface F5, etc.

In the case of the deflection device 24 shown in FIG. 4b, the deflection of the seed laser beam 10 consequently alternates between the laser disk 2 and a respective pair of mirror surfaces F2, F3; F4, F5; F5, F6; . . . , F34, F35 arranged adjacently in the shown example. The beam path of the seed laser beam 10 between the laser disk 2 and the mirror surfaces F2, F3; F4, F5; F5, F6; . . . , F34, F35, more precisely the projection thereof in the XY-plane, is also depicted in FIG. 3b. In the example shown in FIG. 4b, the deflection device 25 has a further through opening 29 for output coupling the seed laser beam 10 from the disk laser amplifier 1. As likewise evident from FIG. 3b, the mirror surfaces F2 to F35 are arranged in three ring regions RB1, RB2, RB3 about the center axis 19 of the main body 27 which corresponds to the center axis of the laser disk 2. It is understood that the mirror surfaces F2 to F35 can also be arranged differently on the main body 27 of the deflection device 25. It is advantageous, but not mandatory, for all reflective optical elements 26 of the deflection device 25 to be fastened to one and the same main body 27.

FIG. 5 shows an optical arrangement in the form of a disk laser 1a which substantially differs from the disk laser amplifier 1 shown in the context of FIG. 1 in that a laser beam creation device in the form of a resonator 30 is provided in place of the seed laser 9, shown there, for the creation of a laser beam 10 having a fundamental mode M0. The resonator 30 comprises two reflectors in the form of end mirrors 31, 32, a resonator path 33 in which the laser disk 2 is also arranged being formed therebetween. A laser beam 10 with a fundamental mode M0 is created in the resonator 30 by pumping the laser disk 2, and this laser beam passes through the laser disk 2 in a laser field volume 12 within the pump volume 8, in a manner analogous to FIG. 2.

The disk laser 1a shown in FIG. 5 also comprises an auxiliary resonator 13 in order to create a spatial distribution of the gain g and of the phase o in the laser disk 2, with the spatial distribution being as constant as possible. The auxiliary resonator 13 is designed as described in the context of FIG. 1 and differs therefrom merely in the fact that an “inverse” stop is arranged in the auxiliary resonator 13 as mode suppression element, i.e., a transmissive optical element 17a which comprises a radiation-absorbing region 17 in the center or along the beam axis 19 of the auxiliary resonator 13 and which is transparent outside of this region. In the case of the disk laser 1a, too, a laser beam 10 having a substantially constant phase angle q and hence a good beam quality can be output coupled from the resonator 30 by means of the auxiliary resonator 13 in the manner described further above in the context of the disk laser amplifier 1. In the example shown in FIG. 5, the laser beam 10 is output coupled at the second, concave end mirror 32, which has a partially transmissive embodiment for this purpose. However, it is understood that the laser radiation 10 can also be output coupled from the resonator 30 in a different way.

As has been described further above, the mode suppression element 17 may also serve to suppress other modes than the fundamental mode M0 of the auxiliary resonator radiation field 15. For example, it is optionally possible to additionally suppress the first higher mode M1 or, as a matter of principle, it is possible to suppress all those modes which (partially) overlap with the modes of the laser beam 10 in the pump volume 8 of the laser disk 2, in order to homogenize the gain g in the pump volume 8 to the best possible extent.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An optical arrangement comprising:
a disk-shaped laser-active medium configured to create an optical gain upon being pumped within a pump volume,
a laser beam incoupler for input coupling a laser beam as a seed laser beam into the laser-active medium, wherein the laser beam interacts with the laser-active medium, and
an auxiliary resonator for creating an auxiliary resonator radiation field, wherein the auxiliary resonator radiation field interacts with the laser-active medium, wherein the auxiliary resonator is configured to suppress at least one mode of the auxiliary resonator radiation field that overlaps with at least one mode of the laser beam in the pump volume.

2. The optical arrangement as claimed in claim 1, wherein the auxiliary resonator is configured to suppress a fundamental mode of the auxiliary resonator radiation field.

3. The optical arrangement as claimed in claim 1, wherein the auxiliary resonator comprises at least one mode suppression element for suppressing the at least one mode of the auxiliary resonator radiation field.

4. The optical arrangement as claimed in claim 3, wherein the mode suppression element for suppressing the at least one mode comprises a radiation-suppressing region arranged centrally in relation to a beam axis of the auxiliary resonator radiation field.

5. The optical arrangement as claimed in claim 4, wherein the radiation-suppressing region is formed on a reflective or transmissive optical element of the auxiliary resonator.

6. The optical arrangement as claimed in claim 1, wherein the auxiliary resonator comprises a setting device for setting a power loss of the auxiliary resonator.

7. The optical arrangement as claimed in claim 6, wherein the setting device forms an output coupling device of the auxiliary resonator, wherein the output coupling device is configured to set a power component of the auxiliary resonator radiation field output coupled from the auxiliary resonator.

8. The optical arrangement as claimed in claim 7, wherein the output coupling device comprises a polarization-influencing element and a partially transmissive polarization-dependent reflector.

9. The optical arrangement as claimed in claim 6, further comprising: a control device for controlling the setting device for setting the power loss of the auxiliary resonator.

10. The optical arrangement as claimed in claim 9, wherein the control device is configured to set the power loss of the auxiliary resonator such that a substantially spatially constant optical gain is created in at least a ring-shaped portion of the pump volume of the laser-active medium.

11. The optical arrangement as claimed in claim 1, further comprising a reflector arranged on one side of the disk-shaped laser-active medium.

12. The optical arrangement as claimed in claim 11, further comprising a deflection device for deflecting the laser beam that is reflected at the reflector, back to the laser-active medium.

13. The optical arrangement as claimed in claim 12, wherein the deflection device comprises a plurality of reflective elements on which mirror surfaces for deflecting the laser beam are formed, the mirror surface of each respective reflective element being aligned such that the laser beam is deflected from the respective mirror surface to another mirror surface via the laser-active medium.

14. The optical arrangement as claimed in claim 1, further comprising: a pump radiation incoupler for input coupling pump radiation into the laser-active medium for creating the optical gain within the pump volume.

15. A method for amplifying a laser beam, the method comprising:
pumping a disk-shaped laser-active medium for creating an optical gain within a pump volume of laser-active medium,
input coupling the laser beam into the laser-active medium, the laser beam being input coupled into the laser-active medium as a seed laser beam, and the laser beam interacting with the laser-active medium, and
creating an auxiliary resonator radiation field using an auxiliary resonator, the auxiliary resonator radiation field interacting with the laser-active medium, wherein at least one mode of the auxiliary resonator radiation field that overlaps with at least one mode of the laser beam in the pump volume is suppressed.

16. The method as claimed in claim 15, wherein a power loss of the auxiliary resonator for creating the auxiliary resonator radiation field is set such that a substantially spatially constant optical gain is created in a ring-shaped portion of the pump volume of the laser-active medium.

17. The method as claimed in claim 15, wherein the laser beam is created in a resonator containing the laser-active medium.
